(19) United States
(12) Patent Application Publication
(10) Pub. No.: US 2014/0099114 A1
(43) Pub. Date: Apr. 10, 2014

(54) OPTICAL SIGNAL TRANSMITTING APPARATUS, OPTICAL FREQUENCY DIVISION MULTIPLEX TRANSMISSION SYSTEM, AND OPTICAL SIGNAL COMMUNICATION METHOD

(71) Applicant: FUJITSU LIMITED, Kawasaki-shi (JP)

(72) Inventors: Masato NISHIHARA, Kawasaki (JP); Toshiki TANAKA, Setagaya (JP); Tomoo TAKAHARA, Kawasaki (JP); Tomoyuki KATO, Yokohama (JP); Shigeki WATANABE, Kawasaki (JP)

(73) Assignee: FUJITSU LIMITED, Kawasaki-shi (JP)

(21) Appl. No.: 13/975,716

(22) Filed: Aug. 26, 2013

(30) Foreign Application Priority Data
Oct. 9, 2012 (JP) 2012-223875

(51) Int. Cl. H04J 14/02

(52) U.S. Cl. CPC H04J 14/0238
USPC 398/67; 398/69

(57) ABSTRACT

An optical signal transmitting apparatus is disposed in an optical frequency division multiplex transmission system that includes plural nodes that are in an optical transmission path and respectively use a unique frequency to frequency-multiplex information with a carrier wave to transmit the information to an optical signal receiving apparatus in the optical transmission path. The optical signal transmitting apparatus outputs the carrier wave and includes a transmitting unit into which information to be delivered to the nodes is input, the transmitting unit transmitting the information using a frequency that does not overlap the unique frequencies used by the nodes; and a multiplexing unit that frequency-multiplexes output of the transmitting unit and the carrier wave, and sends the frequency-multiplexed output to the optical transmission path.

### CROSS REFERENCE TO RELATED APPLICATIONS

This application is based upon and claims the benefit of priority of the prior Japanese Patent Application No. 2012-223875, filed on Oct. 9, 2012, the entire contents of which are incorporated herein by reference.

### FIELD

The embodiments discussed herein are related to an optical signal transmitting apparatus, an optical frequency division multiplex transmission system, and an optical signal communication method that employ a scheme of adding a sub-carrier modulation signal to a carrier wave and transmitting the signal and the wave.

### BACKGROUND

Wavelength division multiplexing (WDM) is a technique of multiplexing optical signals of wavelengths (optical carrier frequencies) that differ from one another. According to WDM, base band modulation is executed for each carrier wave among carrier waves of differing wavelengths and an optical coupling and decoupling device executes multiplexing and de-multiplexing of the carrier waves. To multiplex at narrow wavelength (frequency) intervals, highly precise wavelength control is required of the transmitters and wavelength de-multiplexer. Consequently, multiplexing at narrow wavelength (frequency) intervals is difficult.

Optical frequency division multiplexing (FDM) may be performed. In a system employing optical FDM, along an optical transmission path such as an optical fiber, plural nodes are disposed and a carrier wave (a carrier light beam) is transmitted from a light source of a transmitting apparatus disposed at the starting point of the optical transmission path. Data signals at different sub-carrier frequencies are multiplexed and transmitted with the carrier wave from the plural nodes. The receiving side (a receiving apparatus) disposed at the end point of the optical transmission path receives information transmitted from the nodes (see, e.g., Japanese Laid-Open Patent Publication No. 2011-215603).

In the system employing optical FDM, the data signals are multiplexed with one carrier wave in a single optical transmission path and therefore, the receiving side merely has to receive the carrier wave and therefore, can receive the information transmitted by the plural nodes by a simple configuration compared to that of the WDM.

In a system employing conventional optical FDM, although the information concerning the transmitting apparatus at each of the nodes can be aggregated by the receiving apparatus using the downlink transmission, the designation of nodes along the optical transmission path and the transmission of the information to the designated nodes cannot be performed. Although a single optical transmission path is used for the optical FDM, the receiving apparatus is disposed at the ending point of the optical transmission path. Therefore, no uplink transmission to the nodes can be executed from the receiving apparatus.

For example, the nodes of the entire optical FDM system can centrally managed when a control signal can be transmitted to each of the nodes. However, the nodes can not be controlled conventionally through the optical transmission path.

### SUMMARY

According to an aspect of an embodiment, an optical signal transmitting apparatus is disposed in an optical frequency division multiplex transmission system that includes plural nodes that are in an optical transmission path and respectively use a unique frequency to frequency-multiplex information with a carrier wave to transmit the information to an optical signal receiving apparatus in the optical transmission path. The optical signal transmitting apparatus outputs the carrier wave and includes a transmitting unit into which information to be delivered to the nodes is input, the transmitting unit transmitting the information using a frequency that does not overlap the unique frequencies used by the nodes; and a multiplexing unit that frequency-multiplexes output of the transmitting unit and the carrier wave, and sends the frequency-multiplexed output to the optical transmission path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of an optical frequency division multiplex transmission system according to a first embodiment;

FIG. 2 is a diagram of the optical frequency division multiplex transmission system according to a second embodiment;

FIG. 3 is a flowchart of an example of the content of control executed by a data station;

FIG. 4 is a diagram of an example of a configuration of a system to transmit carrier wave appended signals based on time multiplex;

FIG. 5 is a diagram of an example of a configuration of a system to transmit carrier wave appended signals and node appended signals based on multi-carrier modulation; and

FIG. 6 is an explanatory diagram of signal production executed based on the multi-carrier modulation.

### DESCRIPTION OF EMBODIMENTS

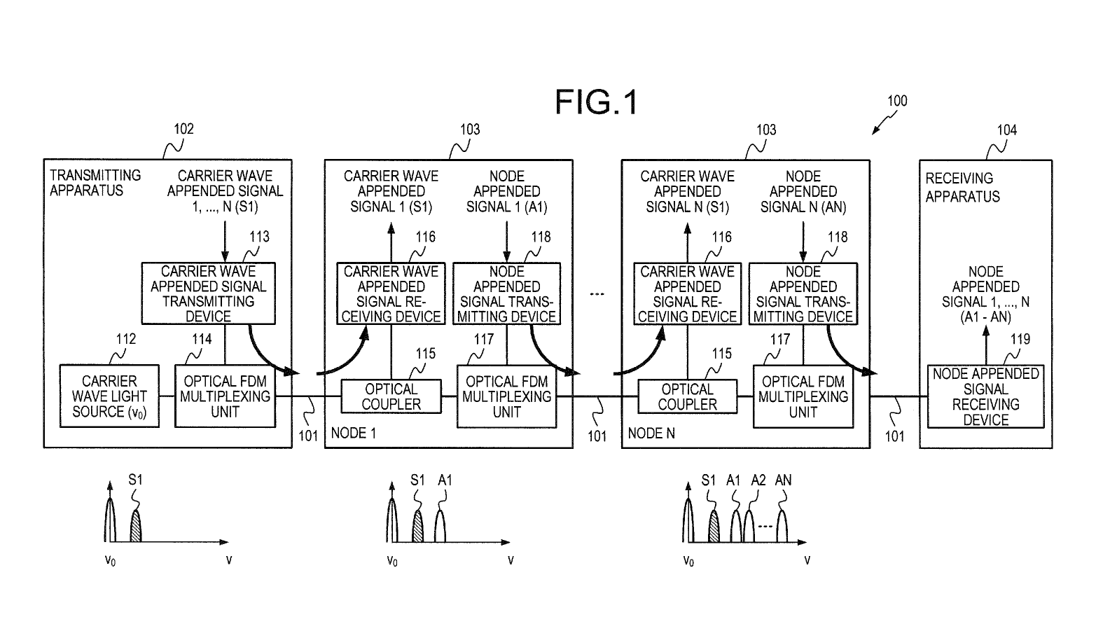

Preferred embodiments of the disclosed technology will be described in detail with reference to the accompanying drawings. FIG. 1 is a diagram of an optical frequency division multiplex transmission system according to a first embodiment. The network depicted in FIG. 1 is configured by a bus-type optical transmission path. Depiction of the units thereof include signals output from the units (the horizontal axis represents frequency and the vertical axis represents optical power).

An optical frequency division multiplex (FDM) transmission system 100 includes an optical transmission path 101 such as an optical fiber, and plural communication apparatuses disposed on the optical transmission path 101. Roughly classifying by function, the communication apparatuses include an optical signal transmitting apparatus (a transmitting apparatus) 102, plural nodes 103 in the optical transmission path 101, and an optical signal receiving apparatus (a receiving apparatus) 104.

The transmitting apparatus 102 includes a carrier wave light source 112, a carrier wave appended signal transmitting device 113, and an optical FDM multiplexing unit 114. The carrier wave light source 112 inserts a carrier wave (of a frequency υ0) such as a continuous wave (CW) light beam into the optical transmission path 101. The carrier wave appended signal transmitting device 113 receives input of common information or individual information 1 to N to be transmitted to the plural nodes 103 as a carrier wave appended signal S1 and the frequency of the carrier wave appended signal S1 is set to be a sub-carrier frequency that is different from the frequency of the carrier wave. The carrier wave appended signal S1 is a signal that is modulated based on a multi-carrier modulation scheme. The optical FDM multiplexing unit 114 sends the carrier wave appended signal S1 to the optical transmission path 101 and causes the carrier wave appended signal S1 to be coupled with the carrier wave.

Each of the nodes 1 to N (103) includes an optical coupler 115, a carrier wave appended signal receiving device 116, an optical FDM multiplexing unit 117, and a node appended signal transmitting device 118. The nodes 1 to N (103) have a data transmission function of sending individual node appended signals A (A1 to AN) to the optical transmission path 101 and cause the individual node appended signals A to be transmitted to the receiving apparatus 104. The nodes 103 have a data reception function of extracting the carrier wave appended signal S1 transmitted from the transmitting apparatus 102.

The internal configuration of each of the nodes will be described taking node 1 (103) as an example. The node appended signal transmitting device 118 assigns the node appended signal A1 input thereinto to the sub-carrier frequency that is different from the frequency of the carrier wave. In this case, the frequency of the node appended signal A1 is also different from the sub-carrier frequency of the carrier wave appended signal S1 used by the other nodes 2 to N (103). The optical FDM multiplexing unit 117 couples the node appended signal A1 to the carrier wave and sends the coupled signal and the carrier wave to the optical transmission path 101.

Thus, the N nodes 103 send the node appended signals A1 to AN to the optical transmission path 101. The node appended signals A1 to AN are a group of frequency division multiplexed signals and are transmitted to the receiving apparatus 104 through the optical transmission path 101.

The optical coupler 115 of the node 1 (103) branches the optical signal (transmission signal) and outputs the resulting optical signal branches to the carrier wave appended signal receiving device 116. The carrier wave appended signal receiving device 116 separates the sub-carrier frequency of the carrier wave appended signal S1, extracts only the carrier wave appended signal S1, executes a process for receiving (demodulating) the carrier wave appended signal S1, and outputs the carrier wave appended signal S1 to the node 1 (103). The optical coupler 115 of the node 1 (103) may be configured to directly branch the carrier wave appended signal S1 from the optical signal (transmission signal).

Similarly, each of the nodes 2 to N (103) executes the process for receiving the carrier wave appended signal S1. The carrier wave appended signal S1 is a signal that is modulated based on the multi-carrier modulation scheme and includes not only the information common to the nodes 1 to N but also individual information for the nodes 1 to N.

For example, the carrier wave appended signal S1 is usable as an individual control signal for the nodes 1 to N (103). In this case, the transmitting apparatus 102 uses the carrier wave appended signal S1 and thereby, can individually control each of the nodes 1 to N through the optical transmission path 101. For example, the carrier wave appended signal S1 is usable as a control signal to individually control the presence or absence of a transmission session of each of the node appended signals A1 to AN transmitted respectively by the nodes 1 to N, and is also usable as a control signal to control for each of the nodes, the setting and change of the sub-carrier frequency of each of the node appended signals A1 to AN respectively transmitted by the nodes 1 to N. The carrier wave appended signal S1 is not only used as the control signal but also can transmit the common information or the individual information (data) to the nodes 1 to N from the transmitting apparatus 102.

The receiving apparatus 104 includes a node appended signal receiving device 119. The node appended signal receiving device 119 collectively receives the node appended signals A1 to AN transmitted from the plural nodes 1 to N in the optical transmission path 101, separates the sub-carrier frequencies of the nodes 1 to N from each other, extracts and demodulates a data modulation component, and outputs the plural node appended signals A1 to AN. Thus, the receiving apparatus 104 can receive all of the node appended signals A1 to AN transmitted from the nodes 1 to N (103) and can centrally execute the data processing.

Details of the multiplexing of the node appended signals A1 to AN with the carrier wave executed by each of the nodes 1 to N (103) and the multiplexing of the carrier wave appended signal S1 executed by the transmitting apparatus 102, using the optical FDM technique, will be described later.

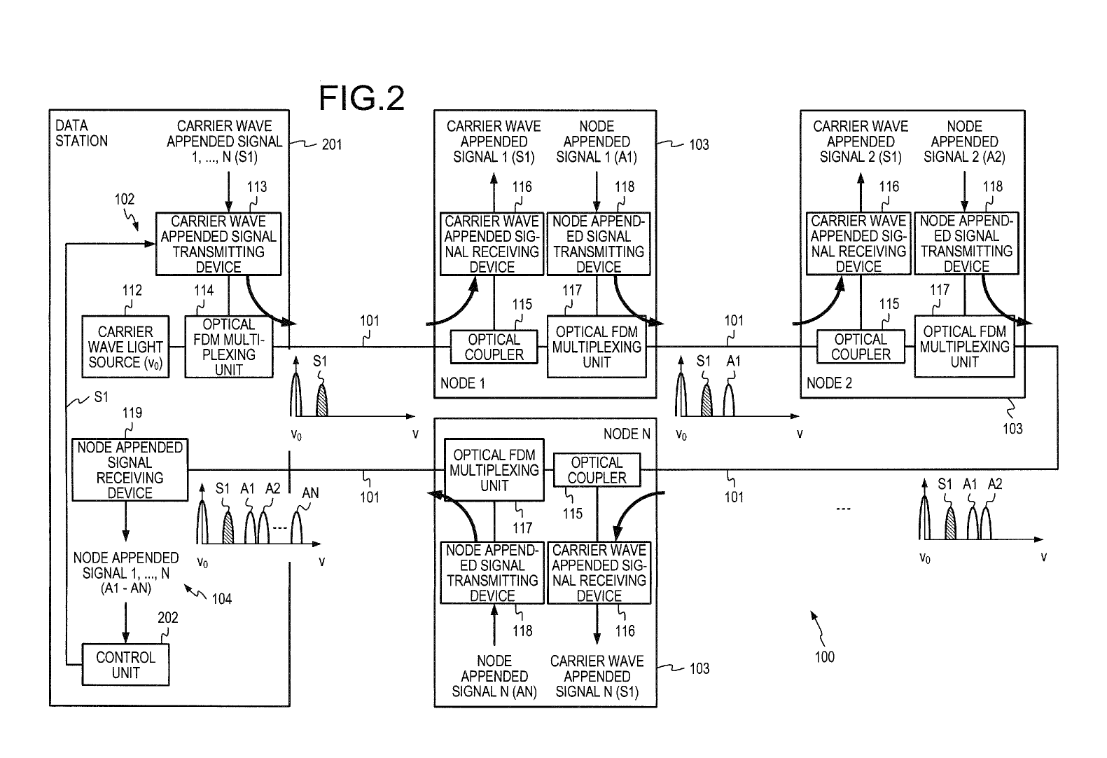

FIG. 2 is a diagram of the optical frequency division multiplex transmission system according to a second embodiment. Although the configuration of each of the units of FIG. 2 is substantially same as that of FIG. 1, a data station 201 includes the transmitting apparatus 102 and the receiving apparatus 104 of FIG. 1. The optical transmission path 101 is a loop-back path that is disposed having therein the transmitting apparatus 102 as the starting point and the receiving apparatus 104 as the ending point through the plural nodes 103. The data station 201 newly includes a function of a control unit 202.

The data station 201 only has to have functions of the transmitting apparatus 102, the receiving apparatus 104, and the control unit 202. The transmitting apparatus 102, the receiving apparatus 104, and the control unit 202 may each be a separate apparatus and further a portion thereof may be implemented as separate apparatuses. The control unit 202 includes a CPU, memory, etc. The CPU executes a program and thereby, executes a predetermined process.

In the data station 201, the transmitting apparatus 102 sends the carrier wave and the carrier wave appended signal S1 to the optical transmission path 101; and the receiving apparatus 104 receives the node appended signals A1 to AN transmitted from the nodes 1 to N (103). The data station 201 functions as a control unit that sends the information to the nodes 1 to N and that also centrally processes information of the information (the node appended signals A1 to AN) transmitted by the nodes 1 to N.

The control unit 202 executes data processing using the node appended signals A1 to AN transmitted from the nodes 1 to N (103). The control unit 202 may be configured to cause an external processing apparatus thereof to execute the data processing. The control unit 202 controls the information of the carrier wave appended signals 1 to N (S1) transmitted by the data station 201 to the nodes 1 to N (103). The control of the information of the carrier wave appended signals 1 to N (S1) can be executed based on the reception of the node appended signals A1 to AN (including the data processing) and, in addition, may independently be executed regardless of the received node appended signals A1 to AN.

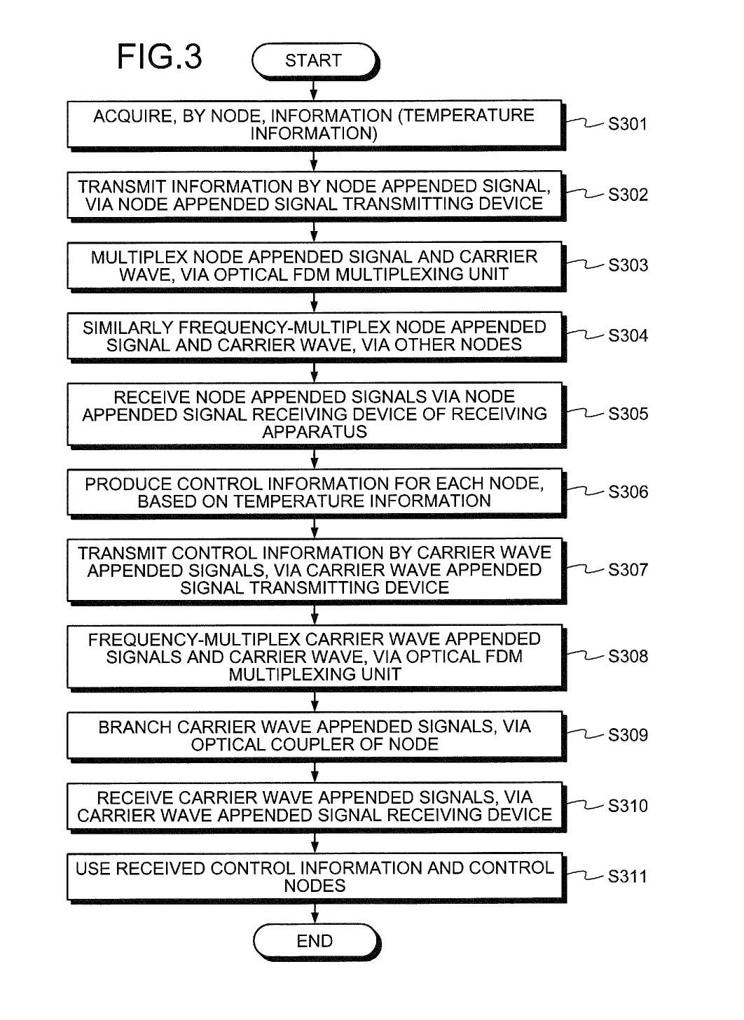

FIG. 3 is a flowchart of an example of the content of the control executed by the data station. In the example, the nodes 1 to N (103) each acquire temperature information concerning the node point and transmit the temperature information to the data station 201 (the receiving apparatus 104) as the node appended signals A1 to AN; and the data station 201 centrally processes the temperature information concerning the nodes 1 to N (103).

The nodes 1 to N (103) first acquire the temperature information (step S301). For example, in the node 1 (103), a temperature sensor not depicted is disposed and acquires the temperature information detected by the temperature sensor. The node appended signal transmitting device 118 transmits the acquired information (the temperature information) as the node appended signal A1 (step S302). The node appended signal A1 to be transmitted is frequency-multiplexed with the carrier wave in the optical transmission path 101 by the optical FDM multiplexing unit 117 (step S303).

Similarly, the other nodes 2 to N (103) frequency-multiplex the node appended signals A2 to AN, each including temperature information with the carrier wave (step S304). In this case, as depicted in FIGS. 1 and 2, the frequencies of the node appended signals A1 to AN to be multiplexed by the nodes 1 to N (103) are different from each other.

The node appended signal receiving device 119 disposed in the receiving apparatus 104 in the data station 201 receives the node appended signals A1 to AN transmitted from the nodes 1 to N (step 5305) and outputs the node appended signals A1 to AN to the control unit 202 of the data station 201. The control unit 202 extracts the temperature information included in the node appended signals A1 to AN and centrally processes the temperature information concerning the nodes 1 to N (103). In the central processing, processes are executed such as monitoring the state of temperature variation in each of the nodes 1 to N (103) setting a threshold value.

The control unit 202 produces control information for each of the nodes 1 to N (103) based on the temperature information concerning the nodes 1 to N (103) (step S306). For example, the control unit 202 increases the acquisition cycle of the temperature information for the node 103 whose temperature variation is small, and decreases the acquisition cycle of the temperature information for the node 103 whose temperature variation is large. When no temperature information can be acquired or when the detected temperature indicates an abnormal value (that is greater than or equal to, or less than or equal to a threshold value), the control unit 202 can reset, etc., the node appended signal transmitting device 118 to normally acquire the temperature information.

The control unit 202 produces control information to control the nodes 1 to N (103) including the control of suspension of the operation and re-starting of the nodes 1 to N (103) and the control of the frequency used (used band) by each of the node appended signals A1 to AN set in the node appended signal transmitting device 118 of each of the nodes 1 to N (103).

The control unit 202 outputs the produced control information S1 to the carrier wave appended signal transmitting device 113 disposed in the transmitting apparatus 102 of the data station 201. The carrier wave appended signal transmitting device 113 includes the control information S1 with the control information S1 in each of the carrier wave appended signals 1 to N and transmits the resulting signal (step S307). The control information S1 may include different control content for each of the nodes 1 to N or may include control content that is common to all the nodes 1 to N.

The optical FDM multiplexing unit 114 of the transmitting apparatus 102 frequency-multiplexes the carrier wave appended signals 1 to N with the carrier wave and sends the signals and the carrier wave to the optical transmission path 101 (step S308). In FIGS. 1 and 2, “S1” denotes the frequency of each of the carrier wave appended signals 1 to N.

In each of the nodes 1 to N (103), the optical coupler 115 branches the carrier wave appended signals 1 to N transmitted in the optical transmission path 101 (step S309). The carrier wave appended signal receiving device 116 of each of the nodes 1 to N (103) extracts the frequency of the carrier wave appended signal (S1 in FIGS. 1 and 2) and receives the carrier wave appended signals 1 to N (S1) (step S310). In each of the nodes 1 to N (103), a control unit not depicted controls each of the nodes 1 to N (103) independently using the control information S1 of the node included in the carrier wave appended signals 1 to N (step S311). In this case, each of the nodes 1 to N (103) extracts the control content for the node indicated by the control information S1 and controls the node according to the extracted control content.

According to the above configuration, the receiving apparatus 104 can collectively receive the information concerning the nodes 1 to N (103) using the node appended signals A1 to AN. The transmitting apparatus 102 can send to the optical transmission path 101, the control information S1 concerning the nodes 1 to N (103) and thereby, the plural nodes 1 to N (103) can collectively or individually be controlled through the optical transmission path 101.

As depicted in FIG. 2, the optical transmission path 101 is set to be a loop-back path, and the transmitting apparatus 102, the receiving apparatus 104, and the control unit 202 can be disposed in the same data station 201. The control unit 202 can produce the control information S1 based on the content (for example, the temperature variation) of the node appended signals A1 to AN output by the nodes 1 to N (103) received by the receiving apparatus 104. As described, the data station 201 can output the control information to the nodes 1 to N as feedback, based on the information collected from the nodes 1 to N and can remote-control the nodes 1 to N (103).

The frequency multiplexing will be described of the node appended signals A1 to AN with the carrier signal. The node appended signal transmitting device 118 of each of the nodes 1 to N (103) includes, for example, a control light beam producing unit, an optical wave coupling unit, and a non-linear optical medium. The control light beam producing unit produces a control light beam to be a sub-carrier modulation signal at a sub-carrier frequency fj that is a frequency different from and somewhat away from the frequency of the carrier wave. The optical wave coupling device couples the carrier wave (at an optical frequency υ0) and the control light beam produced by the control light beam producing unit. The non-linear optical medium mutually phase-modulates the carrier wave (the carrier light beam) using the control light beam. Thereby, each of the nodes 1 to N (103) multiplexes a frequency division multiplex signal υ0±fj with the carrier wave in a wide band.

The receiving apparatus 104 includes a wavelength dispersion medium having a predetermined amount of dispersion against a wavelength, a photo detector (PD) that converts an optical signal received through the wavelength dispersion medium into an electrical signal, and a multiplexed signal receiving unit that electrically executes a reception process based on the electrical signal output by the PD. The multiplexed signal receiving unit includes a band-pass filter that transmits only a desired modulation signal, and a phase synchronization circuit that causes the electrical signal after passing through the band-pass filter to phase-synchronize and that demodulates the signal.

The receiving apparatus 104 includes plural wavelength dispersion media whose amounts of wavelength dispersion each differ corresponding to, for example, the frequency of the sub-carrier modulation signal of each of the nodes 1 to N (103). Thus, a data modulation component can be extracted and received from the sub-carrier modulation signal transmitted by each of the plural nodes 1 to N (103). In this manner, the receiving apparatus 104 adds proper dispersion; collectively receives the carrier light beam on which the plural multiplexed signals are superimposed using the photo detector; thereafter, electrically cuts and demodulates the desired modulation frequency (each of the node appended signal A1 to AN) using the band-pass filter; and thereby, can receive the light beam as an intensity modulation signal.

The wavelength dispersion medium as that available in the market can be an ordinary optical fiber (SMF), a dispersion compensation fiber (DCF), a fiber Bragg grating (FBG) whose amount of dispersion is controlled, and a medium formed using an etalon filter.

The receiving apparatus 104, using a steep optical filter, may extract only the one-side waveband component that is on one side of the frequency of the carrier wave as a central frequency, in addition to using the wavelength dispersion medium.

The signal with which the nodes 1 to N (103) multiplex is not limited to the single sub-carrier modulation signal and a multiplexed signal is usable that is formed by adding plural sub-carrier modulation signals each independent from each other.

Optical phase modulation based on phase inter-modulation, optical intensity modulation based on an optical parametric effect, etc. are useable as the optical inter-modulation using the non-linear optical medium in each of the nodes 1 to N (103). An optical fiber, cyclic polarization inverted lithium niobate, a semiconductor optical amplifier, and a high refraction-index difference optical waveguide such as a silicon thin-line waveguide, etc., are usable as the non-linear optical medium. For example, in addition to a highly non-linear optical fiber (HNLF), an optical fiber or a waveguide configuration whose core's non-linear refraction index is increased by doping germanium, bismuth, etc., into the core; an optical fiber or a waveguide configuration whose optical power density is increased by reducing the mode field; an optical fiber or a waveguide configuration using chalcogenide glass; a photonic crystal optical fiber or a photonic crystal waveguide configuration; etc., may also be employed as the optical fiber.

A semiconductor optical amplifier having a quantum well configuration, a quantum dot semiconductor optical amplifier, a silicon photonics waveguide, etc., are also usable as another non-linear optical medium. A device that generates a second-order non-linear optical effect such as three-optical wave mixing, is also usable as yet another non-linear optical medium. In this case, for example, a LiNbO3 waveguide, a GaAlAs element, a second-order non-linear optical crystal, etc., each having a pseudo phase matching structure are also usable as the non-linear optical medium.

In the description above, the frequency multiplex of the node appended signal A1 to AN with the carrier wave executed by the nodes 1 to N (103) has been described. However, the carrier wave appended signals 1 to N (S1) in the transmitting apparatus 102 can also be transmitted to the nodes 1 to N (103) by adding the signals 1 to N (S1) to the carrier wave based on the same configuration as above. In this case, the carrier wave appended signals 1 to N (S1) may be multiplexed using the frequencies that are different from those of the node appended signals A1 to AN.

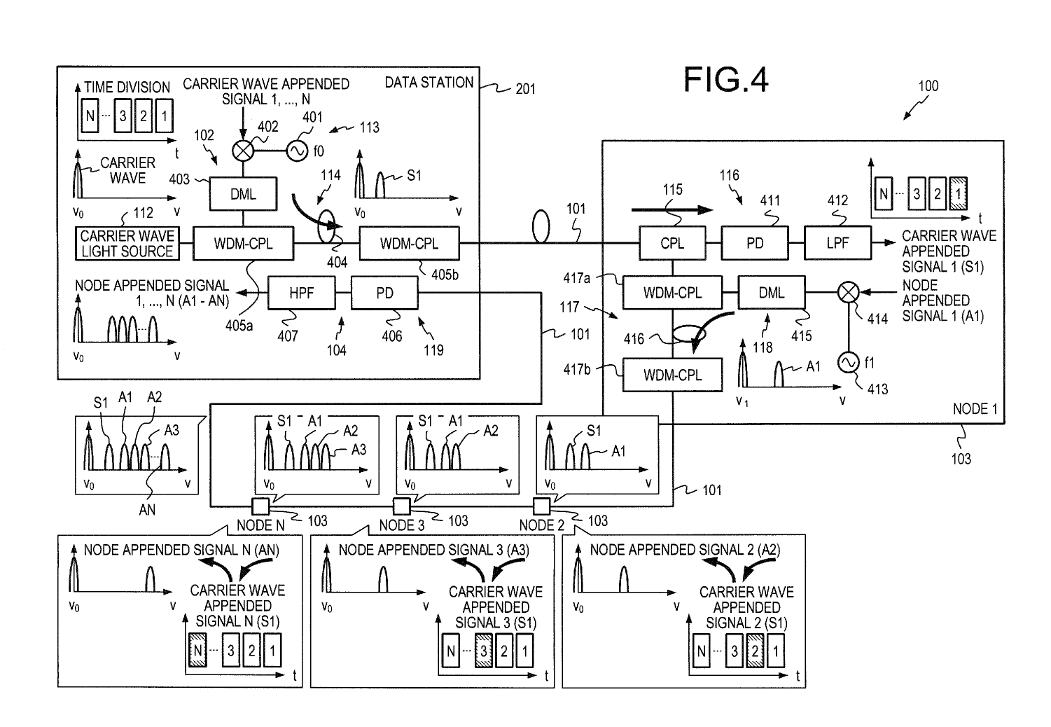

FIG. 4 is a diagram of an example of the configuration of a system to transmit the carrier wave appended signals based on time multiplex. The optical transmission path 101 of the system is basically set to be a loop-back path similarly to that of FIG. 2 and the system includes the data station 201 and the plural nodes 1 to N (103). The configurations same as those of FIG. 2 are given the same reference numerals used in FIG. 2.

The data station 201 includes the transmitting apparatus 102, the receiving apparatus 104, and the control unit 202 not depicted (see FIG. 2). The transmitting apparatus 102 includes the carrier wave light source 112, the carrier wave appended signal transmitting device 113, and the optical FDM multiplexing unit 114. The carrier wave appended signal transmitting device 113 includes an oscillating device 401, a multiplying device 402, and a directly modulated laser (DML) 403. The frequency of the oscillating device 401 is set to be a predetermined frequency f0. The multiplying device 402 multiplies the carrier wave appended signals 1 to N (S1) by the predetermined frequency f0 and outputs the multiplication result to the optical FDM multiplexing unit 114.

The optical FDM multiplexing unit 114 includes, for example, an optical fiber 404 as the non-linear optical medium; and a pair of WDM couplers (CPLs) 405a and 405b at the ends of the optical fiber 404. The WDM coupler (CPL) 405a superimposes the carrier wave appended signals 1 to N (S1) at the predetermined frequency f0 on the carrier wave (at the frequency υ0), thereafter, the optical fiber 404 copies the superimposed signals 1 to N at a frequency (“S1” in FIG. 4) that is different from that of the carrier wave (at the frequency υ0). Thereafter, the WDM coupler (CPL) 405b cuts the components (the carrier wave appended signals 1 to N (S1)) of the control light beam that are superimposed on the carrier wave. Thereby, the data station 201 outputs the carrier wave appended signals 1 to N (S1) at the frequency that is different from that of the carrier wave.

The carrier wave appended signal S1 is set to include information that differs for each of the nodes 1 to N (103) and, as depicted, transmits information 1 to N respectively concerning the nodes 1 to N (103) based on a time division scheme.

The receiving apparatus 104 includes the node appended signal receiving device 119. The node appended signal receiving device 119 includes a photo detector (PD) 406 and a high-pass filter (HPF) 407. The photo detector 406 collectively receives the carrier light beam with which the plural node appended signals A1 to AN are multiplexed and outputs the received carrier light beam to the high-pass filter 407. The high-pass filter 407 electrically cuts and demodulates the frequencies of the node appended signals A1 to AN and outputs the node appended signals A1 to AN to the control unit 202 (see FIG. 2).

Each of the plural nodes 1 to N (103) includes the optical coupler 115, the carrier wave appended signal receiving device 116, the optical FDM multiplexing unit 117, and the node appended signal transmitting device 118. The optical coupler 115 branches and outputs the optical signals to the carrier wave appended signal receiving device 116 on the optical transmission path 101. The carrier wave appended signal receiving device 116 includes a photo detector (PD) 411 and a low-pass filter (LPF) 412. The photo detector 411 receives the carrier light beam that includes the carrier wave appended signals 1 to N (S1) and outputs the carrier light beam to the low-pass filter 412. The low-pass filter 412 electrically cuts and demodulates the frequency of the carrier wave appended signals 1 to N (S1) and outputs the carrier wave appended signals 1 to N (S1).

The control unit (not depicted) extracts the carrier wave appended signal addressed to the corresponding node 103 of the carrier wave appended signals 1 to N (S1). For example, the node 1 (103) extracts only the carrier wave appended signal 1 and the node 2 (103) extracts only the carrier wave appended signal 2. Thereby, the node 1 (103) is enabled to extract the information addressed to the node 1 transmitted by the data station 201. As described, the control unit can execute the control based on the carrier wave appended signal 1 (S1). The carrier wave appended signals 1 to N can each be set to be not only the control information for the node 103 but also the common or the individual information such as data to be delivered to the nodes 1 to N (103).

The node appended signal transmitting device 118 of each of the nodes 1 to N (103) includes an oscillating device 413, a multiplying device 414, and a directly modulated laser (DML) 415. The frequency of the oscillating device 413 is set to be a predetermined frequency f1. The frequency f1 is set to be a frequency that is different from those of the carrier wave appended signals and other nodes (2 to N) 103. The multiplying device 414 of the node 1 (103) multiplies the node appended signal A1 by the predetermined frequency f1 and outputs the multiplication result to the optical FDM multiplexing unit 117.

The optical FDM multiplexing unit 117 includes, for example, an optical fiber 416 as the non-linear optical medium; and a pair of WDM couplers (CPLs) 417a and 417b at the ends of the optical fiber 416. Thereby, the node 1 (103) outputs the node appended signal A1 at the frequency that is different from that of the carrier wave. Similarly, the nodes 2 to N (103) also output the node appended signals A2 to AN at the frequencies that are each different from that of the carrier wave and those of the other nodes 1 to N (103).

According to the above configuration, the nodes 1 to N (103) can respectively extract the information (the carrier wave appended signals 1 to N) addressed to the nodes 1 to N (103) transmitted by the data station 201 based on the time division multiplex. Thereby, the data station 201 is enabled to remote-control the nodes 1 to N (103) by sending the control information thereto through the optical transmission path 101 and is also enabled to send the data to the nodes 1 to N (103) to cause the data to be used in the data processing by the control unit of each of the nodes 1 to N (103).

The data station 201 centrally processes the node appended signals A1 to AN transmitted by the nodes 1 to N (103) and therefore, can transmit to the nodes 1 to N (103) the control information and data that correspond to the variation of the node appended signals A1 to AN. Thereby, the entire system can be configured that includes the data station 201 and the nodes 1 to N (103) connected to each other by the optical transmission path 101. The data station 201 is enabled to control the nodes 1 to N (103) by sending thereto the feedback or transmit the information, based on the variation of the information transmitted thereto by the nodes 1 to N (103).

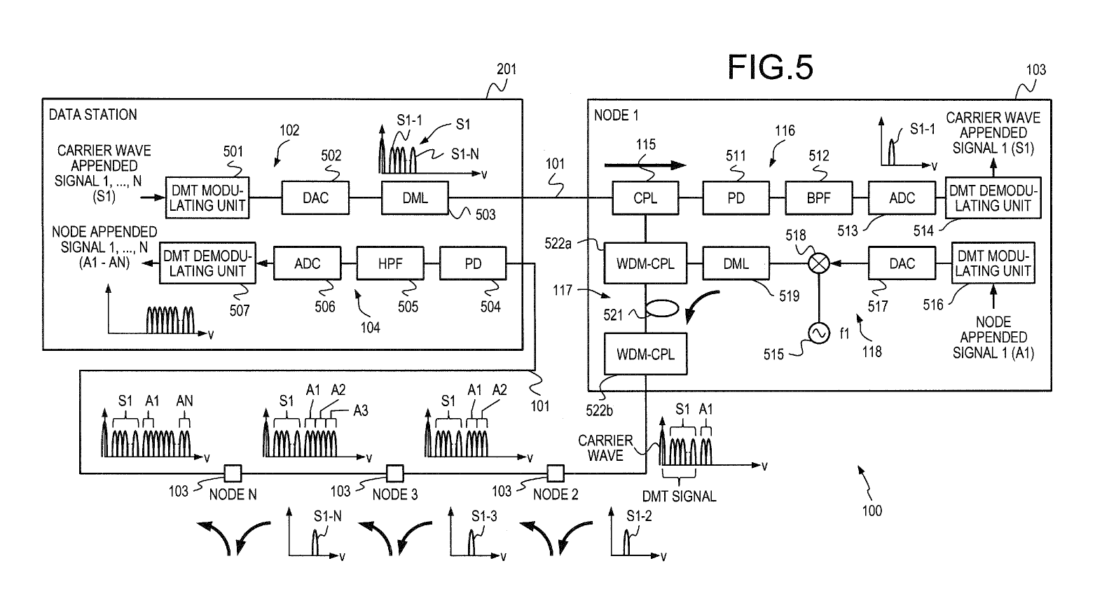

FIG. 5 is a diagram of an example of the configuration of a system to transmit the carrier wave appended signals and the node appended signals based on the multi-carrier modulation. The description will be made with reference to FIG. 5 taking an example of discrete multi tone (DMT) modulation as the multi-carrier modulation.

The transmitting apparatus 102 of the data station 201 includes a DMT modulating unit 501, a DAC 502, and a DML 503. The DMT modulating unit 501 DMT-modulates the plural carrier wave appended signals 1 to N to be transmitted to the nodes 1 to N. The DAC 502 converts a digital output of the DMT modulating unit 501 into an analog output. The DML 403 executes photo-electric conversion for the output of the DAC 502. Thereby, the transmitting apparatus 102 outputs the (group of) carrier wave appended signals S1 (S1-1, S1-2, . . . , and S1-N) that corresponds to the number of nodes N and that each are at a sub-carrier frequency different from each other, as the carrier wave appended signal S1. A DC component of the carrier wave appended signal S1 is used for the carrier wave by the optical FDM. A predetermined gap (a frequency interval) is provided between each modulated component (carrier wave appended signal S1) and the carrier wave (the DC component).

The receiving apparatus 104 of the data station 201 includes a photo detector (PD) 504, a high-pass filter (HPF) 505, an ADC 506, and a DMT demodulating unit 507. The photo detector 504 collectively receives the carrier light beam with which the plural node appended signals A1 to AN are multiplexed and outputs the received carrier light beam to the high-pass filter 505. The high-pass filter 505 electrically cuts the frequencies of the node appended signals A1 to AN and the ADC 506 converts the analog signal to a digital signal. The DMT demodulating unit 507 demodulates the node appended signals A1 to AN transmitted by the nodes 1 to N (103), from the output of the ADC 506.

Each of the plural nodes 1 to N (103) includes the optical coupler 115, the carrier wave appended signal receiving device 116, the optical FDM multiplexing unit 117, and the node appended signal transmitting device 118. The optical coupler 115 branches the optical signal in the optical transmission path 101 to the carrier wave appended signal receiving device 116. The carrier wave appended signal receiving device 116 includes a photo detector (PD) 511, a band-pass filter (BPF) 512, an ADC 513, and a DMT demodulating unit 514. The photo detector 511 receives the carrier light beam that includes the carrier wave appended signals 1 to N (S1) and outputs the received carrier light beam to the band-pass filter 512. The band-pass filter 512 extracts the carrier wave appended signal of the corresponding node of the carrier wave appended signals 1 to N (S1) and outputs the received carrier wave appended signal to the ADC 513. The ADC 513 converts the analog signal into a digital signal and outputs the digital signal to the DMT demodulating unit 514. The DMT demodulating unit 514 demodulates the carrier wave appended signal 1 (S1) addressed to the corresponding node. The band-pass filter may be disposed in the post-stage of the ADC 513.

The node appended signal transmitting device 118 of each of the nodes 1 to N (103) includes an oscillating device 515, a DMT modulating unit 516, a DAC 517, a multiplying device 518, and a directly modulated laser (DML) 519. The frequency of the oscillating device 515 of the node 1 (103) is set to be the predetermined frequency f1. The frequency f1 is set to be a frequency that is different from those of the carrier wave appended signals and those of the other nodes (2 to N) 103.

The DMT modulating unit 516 of the node 1 (103) DMT-modulates the node appended signal A1 input thereinto and the DAC 517 converts the digital signal into an analog signal and outputs the analog signal to the multiplying device 518. The multiplying device 518 multiplies the node appended signal A1 by the predetermined frequency f1 and outputs the multiplication result to the optical FDM multiplexing unit 117.

The optical FDM multiplexing unit 117 includes, for example, an optical fiber 521 as the non-linear optical medium; and a pair of WDM couplers (CPLs) 522a and 522b at the ends of the optical fiber 521. Thereby, the node 1 (103) outputs the node appended signal A1 at the frequency that is different from that of the carrier wave. Similarly, the nodes 2 to N (103) respectively output the node appended signals A2 to AN at frequencies that each are different from that of the carrier wave and from those of the other nodes 1 to N (103). The node appended signals A2 to AN output respectively from the nodes 1 to N (103) are received by the receiving apparatus 104 of the data station 201.

In the description above, all of the carrier wave appended signals 1 to N and the node appended signals A1 to AN are adapted to be DMT-modulated. However, the node appended signals A1 to AN may be modulated based on not only the DMT modulation scheme but also another scheme that is the multi-carrier modulation scheme.

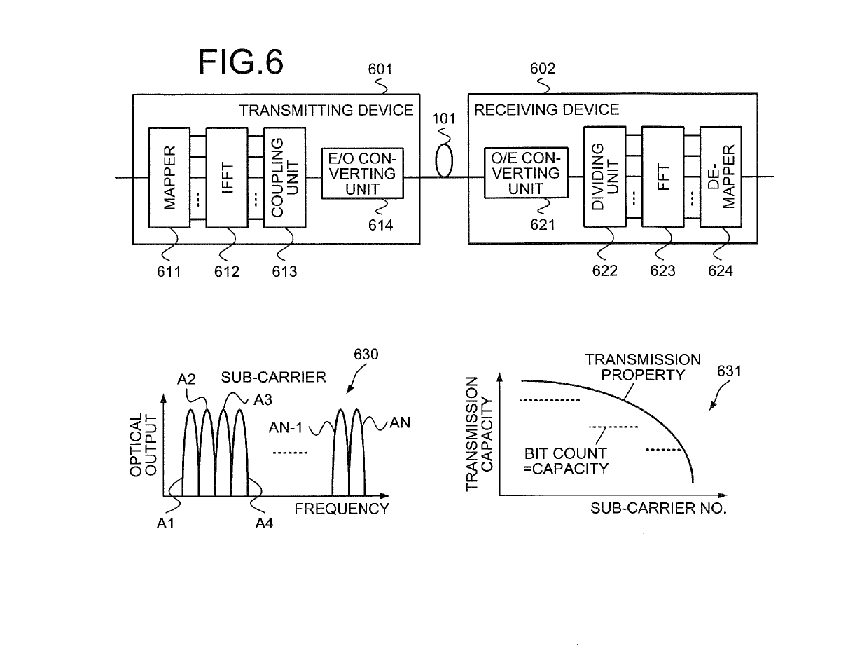

FIG. 6 is an explanatory diagram of signal production executed based on the multi-carrier modulation and depicts a configuration where a signal is transmitted from a transmitting device 601 to a receiving device 602 that form a pair. For example, the transmitting device 601 corresponds to the transmitting apparatus 102 that transmits the carrier wave appended signals 1 to N and the receiving device 602 corresponds to the carrier wave appended signal receiving device 116. The devices are not limited to these and the transmitting device 601 may be applied to the node appended signal transmitting device 118 that transmits the node appended signals A1 to AN and the receiving device 602 may be applied to the receiving apparatus 104 that receives the node appended signals A1 to AN.

The transmitting device 601 includes a mapper 611, an IFFT 612, a coupling unit 613, and an E/O converting unit 614. The receiving device 602 includes an O/E converting unit 621, a dividing unit 622, an FFT 623, and a de-mapper 624. The O/E converting unit 621 corresponds to the PD 511 of FIG. 5. The transmitting device 601 can assign the number of bits that corresponds to the transmission properties such as the S/N of each of the sub-carriers, using the mapper 611. For example, when sub-carriers (for the example of the node appended signals A1 to AN) are assigned that are each different from each other on the frequency axis as depicted in a graph 630, for example, the transmission capacities are each different from each other for each sub-carrier number as depicted in a graph 631. Corresponding to this, allocation is executed to cause the transmission capacity to differ for each sub-carrier number within the permissible range for the transmission property. Thereby, an increase is enabled of the degree of multiple values of the sub-carriers whose S/N ratios are excellent, and improvement is enabled of the frequency use efficiency. Sub-carriers can be set at arbitrary frequencies.

According to the embodiment, in the optical FDM transmission system, the plural nodes in the optical transmission path can send the node appended signal information and the receiving apparatus can collectively receive the information. The plural nodes superimpose on the carrier wave, the sub-carrier modulation signals at the sub-carrier frequencies that each are different from each other. In the embodiment, the transmitting apparatus superimposes on the carrier wave, the common or individual carrier wave appended signals and sends the carrier wave appended signals to the nodes through the optical transmission path. Thereby, each of the nodes can receive the carrier wave appended signal transmitted by the transmitting apparatus through the optical transmission path and can not only simply send the information but also externally capture information.

In the embodiment, the frequencies of the carrier wave appended signals are set in the vicinity of the frequency of the carrier wave. However, the setting of the frequencies is not limited hereto. The frequencies of the carrier wave appended signals only have to avoid overlapping on the frequencies of the node appended signals and therefore, may be set not only in the vicinity of the frequency of the carrier wave but also at, for example, the frequencies each between the frequencies of the node appended signals. When, for example, the control signal is adapted to be sent to each of the nodes as the carrier wave appended signal, the carrier wave appended signal includes a small amount of data compared to that of the node appended signal such as the data transmitted by the node. In this case, the frequency of the carrier wave appended signal may be set to be at the frequency between those of the node appended signals.

According to an embodiment, in the wavelength division multiplex transmission, the transmission of information to plural nodes can be executed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical signal transmitting apparatus that is disposed in an optical frequency division multiplex transmission system that comprises plural nodes that are in an optical transmission path and respectively use a unique frequency to frequency-multiplex information with a carrier wave to transmit the information to an optical signal receiving apparatus in the optical transmission path, the optical signal transmitting apparatus outputting the carrier wave and comprising:
a transmitting unit into which information to be delivered to the nodes is input, the transmitting unit transmitting the information using a frequency that does not overlap the unique frequencies used by the nodes; and
a multiplexing unit that frequency-multiplexes output of the transmitting unit and the carrier wave, and sends the frequency-multiplexed output to the optical transmission path.

2. The optical signal transmitting apparatus according to claim 1, wherein
the transmitting unit frequency-multiplexes the information to be delivered to the nodes and the carrier wave by applying multi-carrier modulation thereto, and sets a predetermined frequency gap between the frequency for the multiplexed information and a frequency of the carrier wave.

3. The optical signal transmitting apparatus according to claim 1, wherein
the transmitting unit transmits information that is common to the plural nodes or individual information of the nodes.

4. The optical signal transmitting apparatus according to claim 3, wherein
the transmitting unit transmits the individual information to the nodes based on time division for each of the nodes.

5. An optical frequency division multiplex transmission system comprising: an optical signal transmitting apparatus that outputs a carrier wave to an optical transmission path; plural nodes that are disposed on the optical transmission path, that each frequency-multiplex information and the carrier wave using a unique frequency, and that each send the information and the carrier wave to the optical transmission path; and an optical signal receiving apparatus that, via the optical transmission path, receives the information sent from each of the nodes, wherein
the optical signal transmitting apparatus comprises:
a transmitting unit into which information to be delivered to the nodes is input, the transmitting unit transmitting the information using a frequency that does not overlap the unique frequencies used by the nodes; and
a multiplexing unit that frequency-multiplexes output of the transmitting unit and the carrier wave, and sends the frequency-multiplexed output to the optical transmission path.

6. The optical frequency division multiplex transmission system according to claim 5, wherein
the nodes each comprise:
a coupler that extracts information addressed to the node; and
a receiving unit that receives the information.

7. The optical frequency division multiplex transmission system according to claim 5, wherein
the optical signal transmitting apparatus and the optical signal receiving apparatus are disposed in a vicinity of each other,
the optical transmission path is a loop-back path through the plural nodes, with the optical signal transmitting apparatus as a starting point thereof and the optical signal receiving apparatus as an ending point thereof, and
the optical frequency division multiplex transmission system comprises a control unit that based on information sent by the nodes and received by the optical signal receiving apparatus, produces information to be delivered to the nodes from the optical signal transmitting apparatus.

8. The optical frequency division multiplex transmission system according to claim 7, wherein
the control unit produces control information to control the nodes, based on the information sent by the nodes.

9. The optical frequency division multiplex transmission system according to claim 5, wherein
the optical signal transmitting apparatus and the nodes assign for the information to be sent based on multi-carrier modulation, bit counts according to a transmission property of a sub-carrier.

10. The optical frequency division multiplex transmission system according to claim 9, wherein
the optical signal transmitting apparatus transmits the information to be delivered to the nodes in a discrete multi-tone modulation scheme.

11. An optical signal communication method of an optical frequency division multiplex transmission system comprising an optical signal transmitting apparatus that outputs a carrier wave to an optical transmission path; plural nodes that are disposed on the optical transmission path, that each frequency-multiplex information and the carrier wave using a unique frequency, and that each send the information and the carrier wave to the optical transmission path; and an optical signal receiving apparatus that, via the optical transmission path, receives the information sent from each of the nodes, the optical signal communication method comprising:
receiving by the optical signal transmitting apparatus, input of information that is to be delivered to the nodes and transmitting, via a transmitting unit, the information using a frequency that does not overlap the unique frequencies used by the nodes; and
frequency-multiplexing by the optical signal transmitting apparatus via a multiplexing unit, the carrier wave and the information transmitted by the transmitting unit, and sending the frequency-multiplexed carrier wave and information to the optical transmission path.
